(19) United States
(12) Patent Application Publication
(10) Pub. No.: US 2025/0157224 A1
(43) Pub. Date: May 15, 2025

(54) EVALUATION METHOD AND EVALUATION DEVICE

(71) Applicant: Panasonic Automotive Systems Co., Ltd., Kanagawa (JP)

(72) Inventors: Shinya AIZAWA, Kanagawa (JP); Fumio KOSUGE, Kanagawa (JP); Makoto HINATA, Kanagawa (JP)

(73) Assignee: Panasonic Automotive Systems Co., Ltd., Kanagawa (JP)

(21) Appl. No.: 19/022,339

(22) Filed: Jan. 15, 2025

Related U.S. Application Data
(63) Continuation of application No. PCT/JP2023/028636, filed on Aug. 4, 2023.

(30) Foreign Application Priority Data
Dec. 27, 2022 (JP) 2022-210330

(51) Int. Cl. G06V 20/54; F24F 11/00; F24F 110/50; G06T 7/292; G07C 5/04; G07C 5/06; G07C 9/10; G08G 1/01; G08G 1/017; G08G 1/04

(52) U.S. Cl. CPC G06V 20/54; F24F 11/0001; G06T 7/292; G07C 5/04; G07C 5/06; G07C 9/10; F24F 2110/50; G06T 2207/30232; G06V 2201/08; G08G 1/0129; G08G 1/0175; G08G 1/04

(57) ABSTRACT

According to an evaluation method, a vehicle number indicating a vehicle and a coming-in time when the vehicle comes in a parking lot are identified based on a first image. A travel route of the vehicle in the parking lot and entering/exiting times of the vehicle with respect to a compartment of the parking lot are identified based on a second image. A going-out time of the vehicle from the parking lot is identified based on a third image. An index value related to an environmental load from when and to when the vehicle comes in and goes out of the parking lot is calculated based on the coming-in time, the travel route, the entering time, the exiting time, and the going-out time. Evaluation information about the parking lot is output. The evaluation information is based on the index value within a designated evaluation period of time.

### CROSS-REFERENCE TO RELATED APPLICATIONS

This application is a continuation of International Application No. PCT/JP2023/028636, filed on Aug. 4, 2023, which claims the benefit of priority of the prior Japanese Patent Application No. 2022-210330, filed on Dec. 27, 2022, entire contents of which are incorporated herein by reference.

### FIELD

The present disclosure relates to an evaluation method and an evaluation device.

### BACKGROUND

As part of an approach for achieving carbon neutrality, a technique has been known, in which an index related to an environmental load such as an emitted CO2 amount and a fuel consumption amount of a vehicle in a parking lot of a commercial facility or the like is evaluated.

For example, there is known a technique of notifying a driver of an evaluation result of fuel saving traveling for a target vehicle (e.g., a patent document JP 2012-27651 A).

When a measure of reducing an environmental load in, for example, a parking lot of a commercial facility or the like is taken, it may be required to grasp the effect of the measure and to consider a more appropriate measure. Therefore, there has been a demand for a technique of visualizing effect verification by quantitatively evaluating an index related to an environmental load.

### SUMMARY

An evaluation method according to one aspect of the present disclosure is implemented by an evaluation device. The evaluation device performs communication with each of a first camera that images a vehicle coming in a parking lot, a second camera that images the vehicle in the parking lot, and a third camera that images the vehicle going out of the parking lot. The evaluation method includes acquiring a first image from the first camera, and identifying, based on the first image, a vehicle number indicating the vehicle and a coming-in time when the vehicle comes in the parking lot. The evaluation method includes acquiring a second image from the second camera, and identifying, based on the second image, a travel route of the vehicle in the parking lot, an entering time when the vehicle enters a compartment of the parking lot, and an exiting time when the vehicle exits from the compartment. The evaluation method includes acquiring a third image from the third camera, and identifying, based on the third image, a going-out time when the vehicle goes out of the parking lot. The evaluation method includes calculating an index value related to an environmental load from when the vehicle comes in the parking lot to when the vehicle goes out of the parking lot. The index value is calculated based on the coming-in time, the travel route, the entering time, the exiting time, and the going-out time. The evaluation method includes outputting evaluation information about the parking lot. The evaluation information is based on the index value related to the environmental load for the vehicle coming in and going out of the parking lot within a designated evaluation period of time.

### BRIEF DESCRIPTION OF DRAWINGS

FIG. 1 illustrates an example of a configuration of an in-parking CO2 emission quantifying system according to an embodiment;

FIG. 2 is a hardware block diagram illustrating an example of a hardware configuration of an in-parking monitoring server and a display device according to the embodiment;

FIG. 3 is a functional block diagram illustrating an example of a functional configuration of the in-parking monitoring server according to the embodiment;

FIG. 4 is a functional block diagram illustrating an example of a functional configuration of the display device according to the embodiment;

FIG. 5 is a sequence diagram illustrating an example of a procedure of evaluation processing to be executed by the in-parking CO2 emission quantifying system according to the embodiment;

FIG. 6 is a flowchart illustrating an example of a procedure of processing executed by the in-parking monitoring server according to the embodiment;

FIG. 7 illustrates an example of a display screen of evaluation information displayed on the display device according to the embodiment;

FIG. 8 illustrates an example of a display screen of evaluation information displayed on the display device according to the embodiment; and

FIG. 9 illustrates another example of the display screen of the evaluation information displayed on the display device according to the embodiment.

### DETAILED DESCRIPTION

An embodiment of an evaluation method, an evaluation system, an evaluation device, a communication method, a program, and a recording medium implemented by an in-parking CO2 emission quantifying system according to the present disclosure will be described below with reference to the drawings.

An in-parking CO2 emission quantifying system 1 according to the embodiment is an example of the evaluation system. The in-parking CO2 emission quantifying system 1 is installed in, for example, a parking lot in a commercial facility. The parking lot is provided in, for example, a site of the commercial facility or an adjacent site. A user of the commercial facility parks a vehicle 70 in the parking lot, and goes shopping at the commercial facility. Note that the in-parking CO2 emission quantifying system 1 according to the embodiment may be applied not only to a parking lot provided in a commercial facility but a parking lot provided in a station or the like.

Note that, in the following embodiment, the action of the vehicle 70 to come in an entrance gate of a parking lot of a commercial facility or the like, namely, to pass through the entrance gate is referred to as “coming-in”. The action of the vehicle 70 to go out of an exit gate of the parking lot, namely, to pass through the exit gate is referred to as “going-out”. The action of the vehicle 70 to enter a compartment (parking section) in the parking lot, namely, to park the vehicle 70 in the compartment is referred to as “entering”. The action of the vehicle 70 to exit from the compartment in the parking lot is referred to as “exiting”.

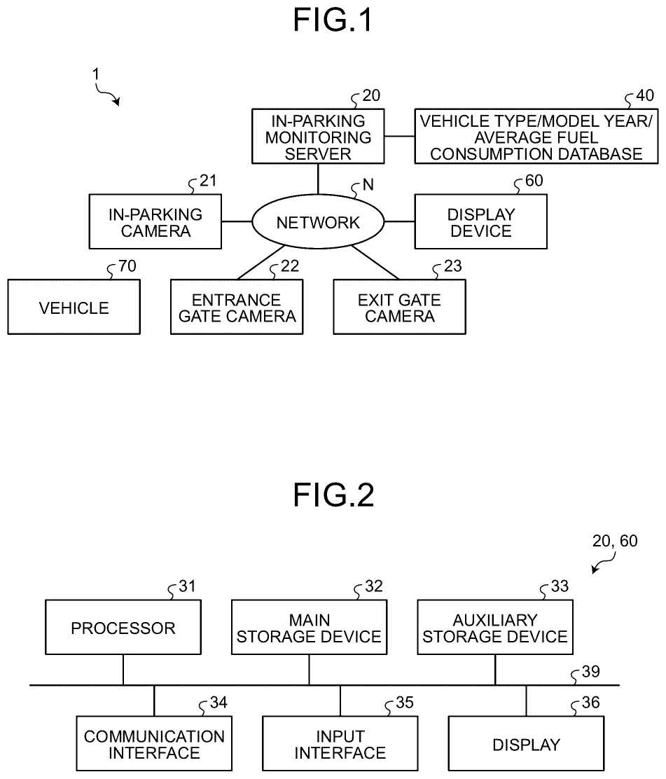

FIG. 1 illustrates an example of a configuration of the in-parking CO2 emission quantifying system according to the embodiment. As illustrated in FIG. 1, the in-parking CO2 emission quantifying system 1 includes an in-parking monitoring server 20, an in-parking camera 21, an entrance gate camera 22, an exit gate camera 23, a vehicle type/model year/average fuel consumption database 40, and a display device 60.

The in-parking monitoring server 20 according to the embodiment is an example of an evaluation device that communicates with each of a first camera, a second camera, and a third camera. The in-parking monitoring server 20 implements the evaluation method according to the embodiment. The in-parking monitoring server 20, the in-parking camera 21, the entrance gate camera 22, the exit gate camera 23, and the display device 60 are communicably connected to each other through a network N. Note that the network N is a wired and/or wireless electric communication line. The network N may be a dedicated line installed in a parking lot or a communication network such as the Internet.

Moreover, the in-parking monitoring server 20 can access the vehicle type/model year/average fuel consumption database 40. In one example, the in-parking monitoring server 20 is communicably connected to at least one server device that stores the vehicle type/model year/average fuel consumption database 40. Note that the vehicle type/model year/average fuel consumption database 40 may be stored inside the in-parking monitoring server 20. The in-parking monitoring server 20 may be able to access the vehicle type/model year/average fuel consumption database 40 via a communication network such as the network N and the Internet. That is, at least one server device that stores the vehicle type/model year/average fuel consumption database 40 may be connected to the network N.

The in-parking monitoring server 20 is a server device that performs various types of processing related to management of the parking lot. The in-parking monitoring server 20 may be implemented by one server device or two or more server devices.

In one example, the in-parking monitoring server 20 calculates a quantitative index value related to an environmental load in the parking lot. Here, the quantitative index value related to an environmental load includes at least one of an amount of CO2 emitted from at least one vehicle 70 and an amount of fuel consumed by at least one vehicle 70 in, for example, a parking lot of a commercial facility or the like.

In one example, the in-parking monitoring server 20 outputs display information for displaying an index value related to a quantified environmental load. This enables the in-parking monitoring server 20 to visualize effect verification before and after a measure taken by the user.

The in-parking camera 21 is an imaging device that can image the vehicle 70 in the parking lot. Here, the in-parking camera 21 according to the embodiment is an example of the second camera. The in-parking cameras 21 are plurally installed on a ceiling or the like of the parking lot. The in-parking cameras 21 are installed so as to be able to monitor the inside of the parking lot completely. Specifically, the in-parking cameras 21 are arranged so as to be able to image a travel route of the vehicle 70 in the parking lot and compartments in the parking lot. In other words, the in-parking cameras 21 are arranged so as to be able to image the vehicle 70 traveling in the parking lot and the vehicle 70 parked in a compartment in the parking lot. Here, the compartment in the parking lot is a parking space for the vehicle 70, and may be expressed as a parking section.

In one example, the in-parking cameras 21 image the inside of the parking lot as needed. The in-parking cameras 21 output in-parking images obtained by imaging to the in-parking monitoring server 20 as needed. Here, the in-parking image according to the embodiment is an example of a second image.

The entrance gate camera 22 is an imaging device that can image the vehicle 70 coming in the parking lot. Here, the entrance gate camera 22 according to the embodiment is an example of the first camera. The entrance gate camera 22 is installed at the entrance gate of the parking lot. The entrance gate may be expressed as a coming-in gate. The entrance gate camera 22 images the vehicle 70 coming in the parking lot within an imaging range including at least a number plate.

In one example, when detecting the vehicle 70 coming in from the entrance gate, the entrance gate camera 22 images the vehicle 70. The entrance gate camera 22 outputs a coming-in image obtained by the imaging to the in-parking monitoring server 20. Here, the coming-in image according to the embodiment is an example of a first image.

The exit gate camera 23 is an imaging device that can image the vehicle 70 going out of the parking lot. Here, the exit gate camera 23 according to the embodiment is an example of the third camera. The exit gate camera 23 is installed at the exit gate of the parking lot. The exit gate may be expressed as a going-out gate. The exit gate camera 23 images the vehicle 70 going out of the parking lot within an imaging range including at least a number plate.

In one example, when detecting the vehicle 70 going out of the exit gate, the exit gate camera 23 images the vehicle 70. The exit gate camera 23 outputs a going-out image obtained by the imaging to the in-parking monitoring server 20. Here, the going-out image according to the embodiment is an example of a third image.

Note that the vehicle is detected by using vehicle detection sensors provided at the entrance gate and the exit gate.

In one example, the vehicle detection sensors are the entrance gate camera 22 and the exit gate camera 23, which can detect the vehicle 70 by performing image recognition processing on the coming-in image and the going-out image.

In one example, the vehicle detection sensors may be the entrance gate camera 22 and the exit gate camera 23, which can output the coming-in image and the going-out image to the in-parking monitoring server 20. The in-parking monitoring server 20 can detect the vehicle 70 by performing image recognition processing on the coming-in image and the going-out image.

That is, the vehicle may be detected not only by the entrance gate camera 22 and the exit gate camera 23 but by the in-parking monitoring server 20. In this case, the entrance gate camera 22 may image the entrance gate as needed, and output the obtained coming-in image to the in-parking monitoring server 20 as needed. The exit gate camera 23 may image the exit gate as needed, and output the going-out image obtained by the imaging to the in-parking monitoring server 20 as needed.

In one example, the vehicle detection sensors may be an infrared sensor or a weight sensor provided at each of the entrance gate and the exit gate, or may be a parking ticket issuing machine provided at the entrance gate or a fare adjustment machine provided at the exit gate. That is, the in-parking monitoring server 20, the entrance gate camera 22, and the exit gate camera 23 may detect the vehicle based on outputs of the infrared sensor, the weight sensor, the parking ticket issuing machine, and the fare adjustment machine. Note that the in-parking CO2 emission quantifying system 1 may include, but is not required to include, the infrared sensor, the weight sensor, the parking ticket issuing machine, and the fare adjustment machine.

The vehicle type/model year/average fuel consumption database 40 indicates the vehicle type, the model year, and the average fuel consumption of the vehicle 70. The vehicle type/model year/average fuel consumption database 40 includes shape data for identifying the vehicle type and the model year of the vehicle 70 from a camera image such as the coming-in image. The vehicle type/model year/average fuel consumption database 40 includes a data table of average fuel consumption for each vehicle type and model year of the vehicle 70. Here, the average fuel consumption may be a catalog value or an actual fuel consumption average value collected from at least one vehicle 70.

The display device 60 is a terminal device used by an administrator of the parking lot. Various information processing devices such as a smartphone, a tablet terminal, and a personal computer (PC) can be appropriately used as the display device 60. Here, the display device 60 according to the embodiment is an example of an information terminal that receives user input, and is an example of an information terminal that displays evaluation information about a parking lot based on display information about the parking lot from the in-parking monitoring server 20. Note that the information terminal that receives user input and the information terminal that displays the evaluation information about the parking lot may be the same information terminal or different information terminals.

Note that the in-parking CO2 emission quantifying system 1 according to the embodiment can provide evaluation service via an application programming interface (API). That is, in the communication method according to the embodiment, operable connection is performed via a network, and evaluation service is provided to another computer system by executing an application. For example, the API is provided by a service provider to use the evaluation service according to the embodiment. The API is an example of an interface of a command for receiving information input for requesting display information such as date and time, a period, and a display resolution and outputting evaluation information including a quantitative index value related to an environmental load in the parking lot.

FIG. 2 is a hardware block diagram illustrating an example of a hardware configuration of the in-parking monitoring server 20 and the display device 60 according to the embodiment.

Each of the in-parking monitoring server 20 and the display device 60 includes a processor 31, a main storage device 32, an auxiliary storage device 33, a communication interface 34, an input interface 35, and a display 36. The processor 31, the main storage device 32, the auxiliary storage device 33, the communication interface 34, the input interface 35, and the display 36 are communicably connected by an internal bus 39.

Note that the in-parking monitoring server 20 is not required to include the input interface 35 and the display 36.

The processor 31 controls the overall operation in each of the in-parking monitoring server 20 and the display device 60. Various processors such as a central processing unit (CPU), a graphics processing unit (GPU), an application specific integrated circuit (ASIC), and a field programmable gate array (FPGA) can be appropriately used as the processor 31.

The main storage device 32 stores temporarily working data in each of the in-parking monitoring server 20 and the display device 60. For example, a random access memory (RAM) can be used as the main storage device 32.

The auxiliary storage device 33 stores various types of data and programs used in each of the in-parking monitoring server 20 and the display device 60. Various storage media and storage devices such as a read only memory (ROM), a hard disk drive (HDD), a solid state drive (SSD), and a flash memory can be appropriately used as the auxiliary storage device 33.

In one example, the auxiliary storage device 33 of the in-parking monitoring server 20 stores map data on the parking lot and map data on cameras. The map data on the parking lot indicates positions of travel paths and compartments in the parking lot and compartment IDs. The map data on cameras indicates positions of the in-parking cameras 21, the entrance gate camera 22, and the exit gate camera 23. Note that these pieces of map data do not need to be actual map data, and may be index information indicating a storage destination of the actual map data. These pieces of map data may be stored in a server device outside the in-parking monitoring server 20.

The communication interface 34 is a circuit for communicating with the outside via the network N in each of the in-parking monitoring server 20 and the display device 60. A communication circuit for wired communication, a communication circuit for wireless communication, and a combination thereof can be appropriately used as the communication interface 34. A communication circuit compatible with various standards such as 3G, 4G, 5G, Wi-Fi (registered trademark), Bluetooth (registered trademark), etc. can be appropriately used as the communication circuit for wireless communication.

The input interface 35 acquires an input operation of the user in each of the in-parking monitoring server 20 and the display device 60. For example, the input interface 35 of the display device 60 receives input of information for the administrator of the parking lot to request display information such as date and time, a period, and a display resolution. An input device such as a keyboard and a touch panel can be appropriately used as the input interface 35.

The display 36 presents a display screen to the user. A liquid crystal display (LCD), an organic electro-luminescence (EL) display, a projector, or the like can be appropriately used as the display 36. The display 36 may be configured as a touch panel display. In this case, a touch panel of the display 36 is provided on, for example, the surface of the display 36, and outputs information in accordance with a touched position. The touch panel of the display 36 is an example of the input interface 35 that acquires an operation input of the user.

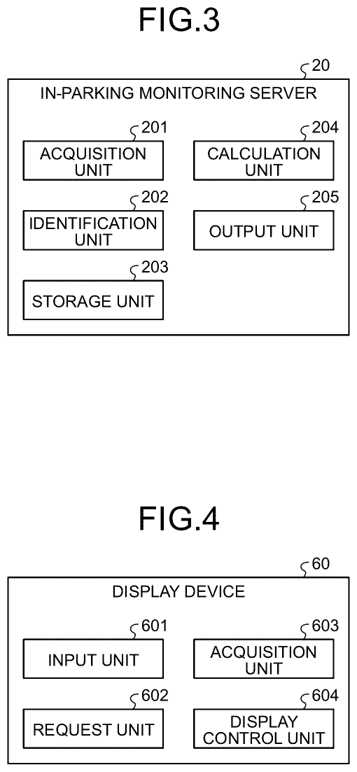

FIG. 3 is a functional block diagram illustrating an example of a functional configuration of the in-parking monitoring server 20 according to the embodiment. In the in-parking monitoring server 20, the processor 31 implements functions of an acquisition unit 201, an identification unit 202, a storage unit 203, a calculation unit 204, and an output unit 205 by executing a program read from the auxiliary storage device 33 and loaded into the main storage device 32.

The acquisition unit 201 acquires a coming-in image from the entrance gate camera 22, an in-parking image from the in-parking camera 21, and a going-out image from the exit gate camera 23. The acquisition unit 201 acquires an information request including designation of an evaluation period of time received from the display device 60.

The identification unit 202 identifies the vehicle number, the vehicle type, and the coming-in time of the vehicle 70 by image analysis on the coming-in image. The identification unit 202 identifies the travel route, the entering time, and the exiting time of the vehicle 70 by image analysis on the in-parking image. The identification unit 202 identifies the going-out time by image analysis on the going-out image.

Here, the vehicle number is the number of a number plate of a coming-in vehicle. Note that the identification unit 202 may recognize the body color of the coming-in vehicle by image analysis on the coming-in image.

For example, the image analysis can be performed by using a machine learning model such as a convolutional neural network (CNN). In this case, in the machine learning model, for example, a parameter is determined so as to output a feature amount related to a vehicle in accordance with input of an image in which the vehicle is captured. Examples of the feature amount related to a vehicle include at least one of the shape, the size, the vehicle number, and the body color of the vehicle, but may include other information. Note that the image analysis may be performed by using a model other than the machine learning model.

Here, the coming-in time is the time when the vehicle 70 comes in the parking lot. The travel route is a route along which the vehicle 70 moves in the parking lot. The travel route may include a route from the entrance gate to a compartment and a route from the compartment to the exit gate. The entering time is the time when the vehicle 70 enters a compartment of the parking lot. The exiting time is the time when the vehicle 70 exits from the compartment. The going-out time is the time when the vehicle 70 goes out of the parking lot.

The storage unit 203 stores the vehicle type/model year/average fuel consumption database 40 serving as fuel consumption information for each of predetermined vehicle types by using, for example, the auxiliary storage device 33. The storage unit 203 stores a correlation coefficient for converting the fuel consumption information into actual fuel consumption information in accordance with actual movements of the vehicle 70 in the parking lot by using the auxiliary storage device 33. The storage unit 203 stores, by the main storage device 32, processing data such as an acquired image of the vehicle 70, identified vehicle information and identified time, travel route, calculated movement time and calculated movement distance, fuel consumption amount, and CO2 emission.

The calculation unit 204 calculates an index value related to an environmental load of the vehicle 70 based on the travel route, the coming-in time, the entering time, the exiting time, and the going-out time of the vehicle 70. Here, the index value related to an environmental load is at least one of a fuel consumption amount and a CO2 emission from when the vehicle 70 comes in the parking lot to when the vehicle 70 goes out of the parking lot.

In one example, the calculation unit 204 reads and acquires fuel consumption information about the vehicle 70 from the vehicle type/model year/average fuel consumption database 40 in accordance with an identified vehicle type. The calculation unit 204 acquires a correlation coefficient stored by the storage unit 203. The calculation unit 204 calculates the movement distance and the movement time of the vehicle 70 in the parking lot based on the travel route, the coming-in time, the entering time, the exiting time, and the going-out time of the vehicle 70. Then, the calculation unit 204 calculates the index value related to an environmental load by using the acquired fuel consumption information and correlation coefficient and the movement distance of the vehicle 70.

In one example, the calculation unit 204 determines the correlation coefficient in accordance with at least one of the movement time, an average speed of the vehicle 70 in the parking lot based on the movement time and the movement distance, the vehicle type, and the model year.

Moreover, the calculation unit 204 generates evaluation information about the parking lot based on an index value related to an environmental load for the vehicle 70 coming in and going out of the parking lot within the designated evaluation period of time.

In one example, the calculation unit 204 generates display information for displaying the evaluation information about the display device 60 as the evaluation information about the parking lot. For example, the display information is used for displaying a total value of index values related to an environmental load within the evaluation period of time designated by the user on the display device 60. For example, the display information is used for displaying a transition of an index value related to an environmental load within the designated evaluation period of time. The transition of the index value is displayed on the display device 60 with a display resolution designated by the user. That is, the display resolution is related to a section of the index value in a case where the transition of the index value is displayed.

The output unit 205 outputs the evaluation information about the parking lot to the display device 60. In one example, the output unit 205 outputs the evaluation information about the parking lot in response to receiving an information request from the display device 60. In other words, the output unit 205 outputs the evaluation information about the parking lot as a response to the information request from the display device 60.

FIG. 4 is a functional block diagram illustrating an example of a functional configuration of the display device 60 according to the embodiment. In the display device 60, the processor 31 implements functions as an input unit 601, a request unit 602, an acquisition unit 603, and a display control unit 604 by executing a program read from the auxiliary storage device 33 and loaded into the main storage device 32.

The input unit 601 receives information for requesting information for requesting display information, such as designation of an evaluation period of time including date and time and a period and designation of a display resolution, based on output of the input interface 35 in accordance with a user operation.

When the input unit 601 receives a user operation for designating an evaluation period of time, the request unit 602 outputs an information request including designation of the evaluation period of time to the in-parking monitoring server 20. When the input unit 601 receives a user operation for designating each of the evaluation period of time and the display resolution, the request unit 602 outputs an information request including designation of the evaluation period of time and designation of the display resolution to the in-parking monitoring server 20.

The acquisition unit 603 acquires the display information output from the in-parking monitoring server 20 in response to the information request. The display information is used for displaying the evaluation information about the parking lot on the display device 60.

The display control unit 604 displays display screens 410, 420, and 430 including the evaluation information about the parking lot on the display 36 based on the display information acquired by the acquisition unit 603.

An operation example of the in-parking CO2 emission quantifying system 1 according to the embodiment will be described below with reference to the drawings. Note that the procedure of processing described below is an example, and it is also possible to change the processing order, delete part of the processing, and add another piece of processing.

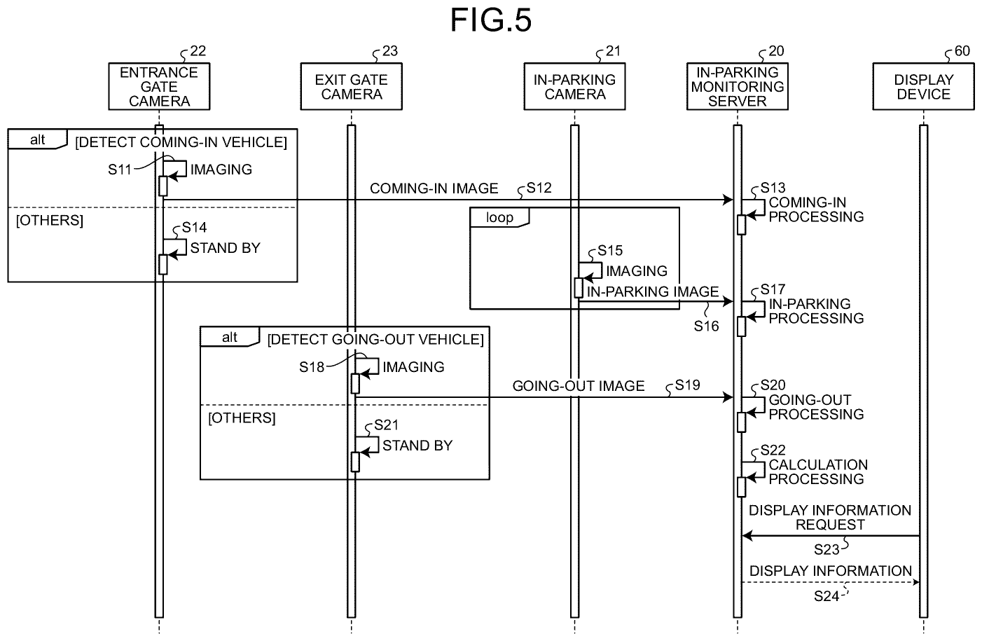

FIG. 5 is a sequence diagram illustrating an example of a procedure of evaluation processing to be executed by the in-parking CO2 emission quantifying system 1 according to the embodiment.

When detecting the vehicle 70 coming in from the entrance gate, the entrance gate camera 22 images the vehicle 70 (S11), and transmits a coming-in image to the in-parking monitoring server 20 (S12). The in-parking monitoring server 20 performs coming-in processing in response to the reception of the coming-in image from the entrance gate camera 22 (S13). The coming-in processing will be described later. In contrast, when not detecting the vehicle 70 coming in from the entrance gate, the entrance gate camera 22 stands by (S14).

The in-parking camera 21 images the inside of the parking lot as needed (S15), and transmits in-parking images to the in-parking monitoring server 20 as needed (S16). The in-parking monitoring server 20 performs in-parking processing by using the in-parking images sequentially acquired from the in-parking camera 21 (S17). The in-parking processing will be described later.

When detecting the vehicle 70 going out of the entrance gate, the exit gate camera 23 images the vehicle 70 (S18), and transmits a going-out image to the in-parking monitoring server 20 (S19). The in-parking monitoring server 20 performs going-out processing in response to the reception of the going-out image from the exit gate camera 23 (S20). The going-out processing will be described later. In contrast, when not detecting the vehicle 70 going out of the exit gate, the exit gate camera 23 stands by (S21).

Moreover, the in-parking monitoring server 20 performs calculation processing at predetermined timing (S22). The calculation processing will be described later. Note that the predetermined timing may include the time when going-out processing for each vehicle 70 is finished, the time when pieces of going-out processing for vehicles 70 in the predetermined number stored in the auxiliary storage device 33 or the like are finished, the time when a gate of the parking lot is closed such as operation end time, any time outside operation hours, the time when a display information request to be described later is received (S23), and timing starting from these pieces of timing. The predetermined timing may come periodically, for example, every day, every two or more days, or every week.

Furthermore, in the display device 60, the input unit 601 receives a user operation of inputting information for requesting display information such as date and time, a period, and a display resolution. The request unit 602 generates a display information request based on the information acquired by the input unit 601 in response to the user operation, and transmits the display information request to the in-parking monitoring server 20 (S23). In response to receiving the display information request from the display device 60, the in-parking monitoring server 20 generates display information for displaying the evaluation information, and transmits the display information to the display device 60 (S24).

The display information may be data on an image displayed as a display screen, or may be various types of data necessary for generating the display screen, such as data of index values of date and time and a resolution in response to the display information request and layout information. That is, an image of a display screen to be displayed on the display device 60 may be generated by the in-parking monitoring server 20 or the display device 60. The display screen of the evaluation information will be described later.

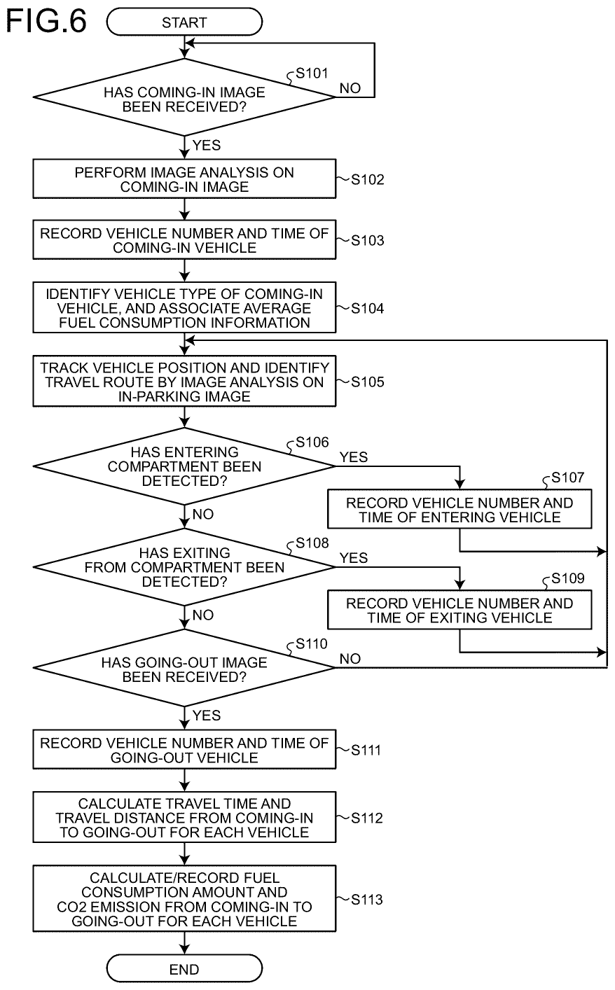

FIG. 6 is a flowchart illustrating an example of a procedure of processing executed by the in-parking monitoring server 20 according to the embodiment. Here, a series of flows for a certain vehicle 70 will be illustrated.

As will be described below, the in-parking monitoring server 20 performs coming-in processing (S101 to S104), in-parking processing (S105 to S109), exiting processing (S110 to S111), and calculation processing (S112 to S113).

The acquisition unit 201 determines whether a coming-in image from the entrance gate camera 22 has been received by the communication interface 34 (S101). When it is not determined that the coming-in image has been received (S101: No), the flow in FIG. 6 stands by until determining that the coming-in image has been received.

When it is determined that the coming-in image has been received (S101: Yes), the acquisition unit 201 acquires the coming-in image from the entrance gate camera 22. The identification unit 202 identifies the vehicle number of the vehicle 70 (coming-in vehicle) that comes in the parking lot and recognizes the shape of the coming-in vehicle by image analysis on the coming-in image (S102). Thereafter, the storage unit 203 stores the vehicle number and the time of the coming-in vehicle by using the auxiliary storage device 33 (S103).

Moreover, the identification unit 202 identifies the vehicle type of the coming-in vehicle with reference to the vehicle type/model year/average fuel consumption database 40 based on the shape of the coming-in vehicle recognized based on the coming-in image. The identification unit 202 reads average fuel consumption of the identified vehicle type. Thereafter, the storage unit 203 associates the average fuel consumption with the vehicle number of the coming-in vehicle, and stores the average fuel consumption by using the auxiliary storage device 33 (S104). Note that the storage unit 203 may further associate the body color with the vehicle number of the coming-in vehicle, and stores the body color by using the auxiliary storage device 33.

The acquisition unit 201 acquires a time series of a plurality of in-parking images from each of the in-parking cameras 21. The identification unit 202 tracks the vehicle position of the vehicle 70 (in-parking vehicle) moving in the parking lot, and identifies the travel route and the vehicle state of the in-parking vehicle by image analysis on each of the sequentially acquired in-parking images (S105).

Here, the vehicle state indicates whether the in-parking vehicle is moving in the parking lot or is parked in a compartment. For example, the identification unit 202 identifies the vehicle position and the vehicle state by using the vehicle number identified by image analysis on the coming-in image and the vehicle number extracted from the in-parking image. Note that the identification unit 202 may identify the vehicle position not by using the vehicle number but by the vehicle type and the body color. The identification unit 202 may identify the vehicle position by using map data on the parking lot indicating positions of travel paths and compartments in the parking lot and compartment IDs, and map data indicating the positions of cameras.

The identification unit 202 determines whether the in-parking vehicle has been detected to enter a compartment (S106). When it is determined that the in-parking vehicle has been detected to enter a compartment (S106: Yes), the storage unit 203 stores, by using the auxiliary storage device 33, the vehicle number of the vehicle 70 (entering vehicle) that enters the compartment and the time when the vehicle 70 enters the compartment (S107).

When it is not determined that the in-parking vehicle has been detected to enter a compartment (S106: No), the identification unit 202 determines whether the entering vehicle has been detected to exit from the compartment (S108). When it is determined that the entering vehicle has been detected to exit from a compartment (S108: Yes), the storage unit 203 stores, by using the auxiliary storage device 33, the vehicle number of the vehicle 70 (exiting vehicle) that exits from the compartment and the time when the vehicle 70 exits from the compartment (S109).

When it is not determined that the entering vehicle has been detected to exit from a compartment (S108: No), the acquisition unit 201 determines whether a going-out image from the exit gate camera 23 has been received by the communication interface 34 (S110).

When it is not determined that the going-out image has been received (S110: No), the flow in FIG. 6 repeats the processing in S105 to S110 until it is determined that the going-out image has been received. That is, as in the flow described above for the coming-in vehicle, the travel route and the vehicle state of the exiting vehicle are identified.

When it is determined that the going-out image has been received (S110: Yes), the acquisition unit 201 acquires the going-out image from the exit gate camera 23. As in the procedure of S102 to S103, the identification unit 202 identifies the vehicle 70 (going-out vehicle) that goes out of the parking lot by image analysis on the going-out image. Then, the storage unit 203 stores the vehicle number and the time of the going-out vehicle by using the auxiliary storage device 33 (S111).

Thereafter, the calculation unit 204 calculates a travel time and a travel distance from coming-in to going-out for each vehicle 70 at predetermined timing (S112).

Moreover, the calculation unit 204 calculates at least one of a fuel consumption amount and a CO2 emission from coming-in to going-out for each vehicle 70 by further using the average fuel consumption read from the vehicle type/model year/average fuel consumption database 40 and stored in association with the vehicle number. Thereafter, the storage unit 203 stores the calculated fuel consumption amount and the CO2 emission for each vehicle 70 by using the auxiliary storage device 33 (S113).

For example, the calculation unit 204 calculates a value of a travel distance from coming-in to going-out per movement time as an average speed at the time when the vehicle 70 travels in the parking lot. Here, the movement time is obtained by subtracting the difference between exiting time and entering time from the difference between going-out time and coming-in time. Alternatively, the movement time is obtained by adding the difference between going-out time and exiting time to the difference between entering time and coming-in time.

For example, the calculation unit 204 calculates at least one of a fuel consumption amount and a CO2 emission from coming-in to going-out for each vehicle 70 by using the average fuel consumption stored in association with the vehicle number, the travel distance from coming-in to going-out, and a predetermined correlation coefficient stored in the auxiliary storage device 33.

Note that the correlation coefficient is a value for converting the average fuel consumption read from the vehicle type/model year/average fuel consumption database 40 and stored in association with the vehicle number into actual fuel consumption in accordance with actual traveling of the vehicle 70 in the parking lot. For example, the actual fuel consumption of the vehicle 70 in the parking lot is correlated not only with the movement distance but with at least one of a movement speed and the movement time. That is, when at least one of the movement speed and the movement time is different, the actual fuel consumption may differ even with the same movement distance. Therefore, the calculation unit 204 is configured to calculate at least one of the fuel consumption amount and the CO2 emission by using the correlation coefficient together with the average fuel consumption and the travel distance.

In one example, the correlation coefficient may be preliminarily determined based on the actual fuel consumption measured for at least one vehicle 70 in the parking lot, and stored in the auxiliary storage device 33.

In one example, the correlation coefficient may be preliminarily determined and stored in the auxiliary storage device 33 based on the size and structure of the parking lot, such as arrangement of travel paths and compartments in the parking lot, and actual fuel consumption measured in another parking lot.

In one example, the correlation coefficient may be preliminarily determined and stored in the auxiliary storage device 33 for, for example, at least one of the vehicle type and the model year.

In one example, the correlation coefficient may be preliminarily determined and stored in the auxiliary storage device 33 as, for example, a table indicating a value of at least one of the actual movement speed and movement time of the vehicle 70 or a value for each section.

In one example, the correlation coefficient may be preliminarily determined and stored in the auxiliary storage device 33 as a function including, as a variable, at least one of the actual movement speed and movement time of the vehicle 70.

Note that the relation between the average fuel consumption, the actual fuel consumption, or the fuel consumption amount and the CO2 emission is preliminarily determined as, for example, a relational expression or a table and stored in the auxiliary storage device 33.

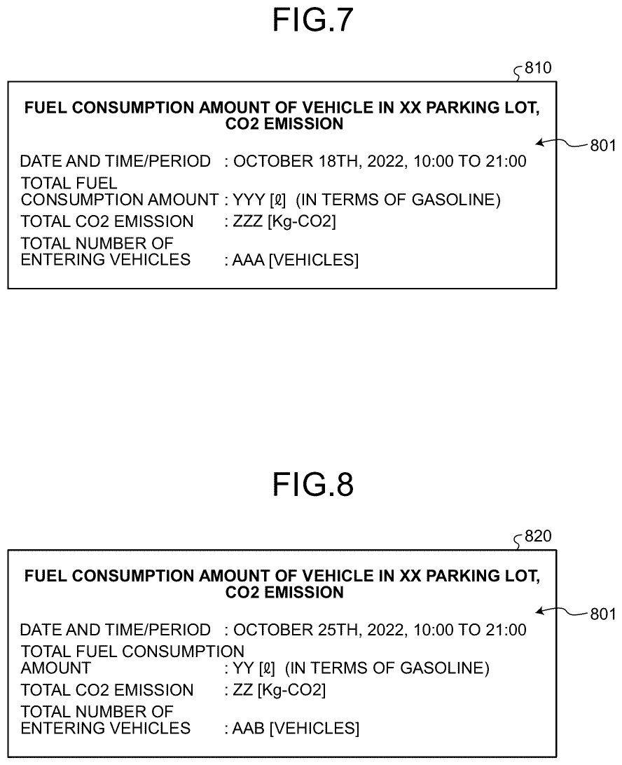

FIGS. 7 and 8 respectively illustrate examples of display screens 810 and 820 of the evaluation information displayed on the display device 60 according to the embodiment. FIG. 7 illustrates an example of the display screen 810 of evaluation information 801 in a case where there is no in-parking congestion mitigation measure, that is, before a measure. FIG. 8 illustrates an example of the display screen 820 of the evaluation information 801 in a case where there is an in-parking congestion mitigation measure, that is, after the measure. Each of the display screens 810 and 820 is based on display information output from the in-parking monitoring server 20 in response to an information request that includes designation of an evaluation period of time.

For example, the in-parking congestion mitigation measure is implemented by an administrator of the parking lot such as the user of the display device 60. The measure includes doubling the number of guides arranged in the parking lot. That is, the in-parking congestion mitigation measure is a target for visualizing the effect verification by the evaluation method according to the embodiment.

Each of the display screens 810 and 820 displays a total value of a fuel consumption amount and a CO2 emission of the vehicle 70 that comes in and goes out of an “XX parking lot” within each designated evaluation period of time as the evaluation information 801 on the parking lot.

The display screen 810 includes the evaluation information 801 in a case where an evaluation period of time “Date and time/time: Oct. 18, 2022, 10:00 to 21:00” before an in-parking congestion mitigation measure is designated. The evaluation information 801 indicates that the total fuel consumption amount is YYY (L) in terms of gasoline and the total CO2 emission is ZZZ (Kg-CO2). The display screen 810 further includes display indicating that the total number of entering vehicles was AAA (vehicles).

The display screen 820 includes the evaluation information 801 in a case where an evaluation period of time “Date and time/time: Oct. 25, 2022, 10:00 to 21:00” after the in-parking congestion mitigation measure is designated. The evaluation information 801 indicates that the total fuel consumption amount is YY (L) in terms of gasoline and the total CO2 emission is ZZ (Kg-CO2). The display screen 810 further includes display indicating that the total number of entering vehicles was AAB (vehicles).

For example, on the display screen 820 in contrast to the display screen 810, when the in-parking congestion mitigation measure of doubling the number of guides in the parking lot is taken, date and time with a similar total number of entering vehicles are extracted, and how much the fuel consumption amount and the CO2 emission in the parking lot are changed can be found.

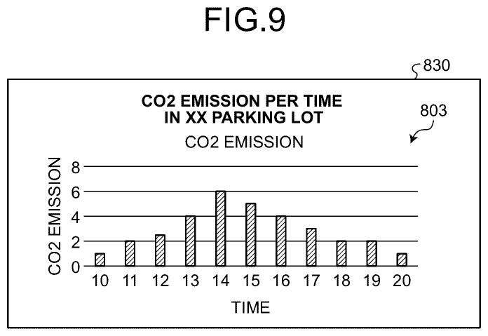

FIG. 9 illustrates another example of a display screen 830 of the evaluation information displayed on the display device according to the embodiment. The display screen 830 is based on display information output from the in-parking monitoring server 20 in response to an information request that includes designation of an evaluation period of time and designation of a display resolution.

Note that, even in a case where the user does not designate the display resolution, an information request including designation of a display resolution set as default in the display device 60 is made, and a similar display screen 830 may be displayed. Alternatively, even in a case where an information request including no designation of a display resolution is made, display information in accordance with designation of a display resolution set as default in the in-parking monitoring server 20 is output from the in-parking monitoring server 20, and a similar display screen 830 may be displayed.

The display screen 830 displays a transition of evaluation information for each time at the designated display resolution regarding the vehicle 70 that comes in and goes out of the parking lot within a designated evaluation period of time as evaluation information 803 on the “XX parking lot”. The display screen 830 illustrates a transition of a CO2 emission in a case where a display resolution for one hour is designated. Note that transition of a fuel consumption amount may be displayed as the transition of evaluation information instead of or in addition to the CO2 emission.

For example, it can be found that there is a peak of CO2 emission at 14:00 on the display screen 830. This enables the user to perform forced ventilation in the parking lot at appropriate timing and appropriate blocking/opening of a temporary entering/exiting gate in accordance with quantified evaluation information about the parking lot.

As described above, a fuel consumption amount and a CO2 emission in the parking lot within any period can be grasped by data accumulation in the evaluation method according to the embodiment. Therefore, fuel consumption amounts and CO2 emissions before and after some measures are taken with a similar number of entering vehicles can be compared, that is, an effect of a measure can be quantitatively evaluated. In other words, according to the evaluation method of the embodiment, an effect of a measure such as various congestion mitigation measures in the parking lot can be visualized by quantifying index values related to an environmental load before and after the taken measure.

Moreover, the user can use the quantified index value related to an environmental load as an index when taking measures such as increasing the number of gates for coming-in to/going-out of the parking lot, blocking or releasing, that is, opening or closing a temporary entering/exiting gate that controls the numbers of coming-in/going-out gates and compartments, increasing the number of facilities for in-parking ventilation, and adjusting operation schedules of the facilities for in-parking ventilation.

Note that, although, in the above-described embodiment, cases have been described in which a user who has checked a display screen of evaluation information considers and takes measures and effect verification of the measures is visualized by the display screen of the evaluation information, this is not a limitation.

For example, the in-parking monitoring server 20 may output control information as evaluation information about the parking lot. The control information is used for operating facilities provided in the parking lot in accordance with an index value related to an environmental load within a designated evaluation period of time.

Examples of the facilities provided in the parking lot include a ventilation facility that ventilates the parking lot, an entrance gate and an exit gate (coming-in/going-out gate) that control coming-in/going-out of the vehicle 70 to/of the parking lot, that is, the number of vehicles 70 in the parking lot, and a temporary entering/exiting gate that controls the number of compartments of the parking lot. Here, the temporary entering/exiting gate partitions a road in an already released parking space or outside the parking lot off a temporary parking space, which is additionally released in a case where there are a large number of vehicles 70 in the parking lot, such as a case where congestion occurs in the parking lot, or in a case where a large number of vehicles 70 are expected.

In one example, the control information output as the evaluation information about the parking lot is used for controlling at least one of ventilation of the parking lot and opening/closing of the temporary entering/exiting gate that controls the number of compartments of the parking lot.

In one example, the in-parking monitoring server 20 generates control information such that at least one of forced ventilation, blocking of the entrance gate, and releasing of the temporary entering/exiting gate is executed in a time zone in which at least one of the fuel consumption amount and the CO2 emission exceeds a threshold preliminarily determined for each thereof, and supplies the control information to a corresponding facility.

Note that, in the above-described embodiment, when the vehicle type of the vehicle 70 is identified as an electric vehicle (EV), tracking of the vehicle 70, calculation of the fuel consumption amount and the CO2 emission, and the like may be omitted. Alternatively, when the sum of index values within a predetermined period is determined, the index values may be treated as data of a value “0”.

Note that, although, in the above-described embodiment, a case where an image obtained by a camera provided in the parking lot, such as the in-parking camera 21, the entrance gate camera 22, and the exit gate camera 23, is used has been described, this is not a limitation. In the evaluation method according to the above-described embodiment, evaluation information can be generated and output by using an image obtained by another imaging device such as a drive recorder mounted in the vehicle 70 and a smartphone of the user of the vehicle 70.

As described above, in the evaluation method according to the embodiment, the fuel consumption amount and the CO2 emission of the vehicle 70 in the parking lot is quantitatively calculated. Specifically, in the evaluation method, movements of each vehicle 70 are measured/recorded by registering a vehicle number from an image obtained by a camera provided in the parking lot and tracking the movements of the vehicle 70 from when the vehicle 70 comes in the parking lot to when the vehicle 70 performs entering and from when the vehicle 70 performs exiting to when the vehicle 70 goes out of the parking lot. In the evaluation method, the movement time and the movement distance of each vehicle 70 is calculated based on data on recorded movements of the vehicle 70, and at least one of the fuel consumption amount and the CO2 emission of each vehicle 70 is calculated as a quantified index value. In the evaluation method, for example, the sum of quantified index values quantified within an evaluation period of time designated by the user is determined.

According to the configuration, as part of approach for the carbon neutrality, a fuel saving amount and a CO2 emission in the entire parking lot can be quantitatively measured in response to a demand for quantitative evaluation on an amount of CO2 emitted by the vehicle 70 in the parking lot of a commercial facility and the like and fuel saving traveling. For example, according to the evaluation method of the embodiment, effect verification of measures can be visualized by comparing pieces of evaluation information based on a quantified index value before and after various congestion mitigation measures and the like in the parking lot are taken. The user such as an administrator of the parking lot can use evaluation information presented by the evaluation method according to the embodiment as an index for taking measures for reducing an environmental load, such as increasing the number of coming-in/leaving gates, blocking the gates, and controlling in-parking ventilation.

Note that, in the above-described embodiment, “determining whether it is A” may be “determining that it is A”, “determining that it is not A”, or “determining whether or not it is A”.

A program to be executed by each device of the in-parking CO2 emission quantifying system 1 according to the embodiment is provided by being recorded in a computer-readable recording medium such as a CD-ROM, an FD, a CD-R, and a DVD in a file in an installable format or an executable format.

Moreover, the program to be executed by each device of the in-parking CO2 emission quantifying system 1 according to the embodiment may be provided by being stored in a computer connected to a network such as the Internet and downloaded via the network. The program to be executed by each device of the in-parking CO2 emission quantifying system 1 according to the embodiment may be provided or distributed via the network such as the Internet.

Furthermore, the program to be executed by each device of the in-parking CO2 emission quantifying system 1 according to the embodiment may be provided by being preliminarily incorporated into a ROM and the like.

According to at least one embodiment described above, an index related to an environmental load in a parking lot of a commercial facility or the like can be quantitatively evaluated.

Although some embodiments of the present invention have been described, these embodiments have been presented as examples, and are not intended to limit the scope of the invention. These embodiments can be implemented in various other forms, and various omissions, substitutions, and changes can be made without departing from the gist of the invention. These embodiments and variations thereof are included in the scope and gist of the invention, and are also included in the invention set forth in the claims and the equivalent scope thereof.

### APPENDIX

The following techniques are disclosed by the above description of the embodiment.

(1)

An evaluation method in an evaluation device, the evaluation device performing communication with each of a first camera that images a vehicle coming in a parking lot, a second camera that images the vehicle in the parking lot, and a third camera that images the vehicle going out of the parking lot, the evaluation method comprising:
acquiring a first image from the first camera, and identifying, based on the first image, a vehicle number indicating the vehicle and a coming-in time when the vehicle comes in the parking lot;
acquiring a second image from the second camera, and identifying, based on the second image, a travel route of the vehicle in the parking lot, an entering time when the vehicle enters a compartment of the parking lot, and an exiting time when the vehicle exits from the compartment;
acquiring a third image from the third camera, and identifying, based on the third image, a going-out time when the vehicle goes out of the parking lot;
calculating an index value related to an environmental load from when the vehicle comes in the parking lot to when the vehicle goes out of the parking lot, the index value being calculated based on the coming-in time, the travel route, the entering time, the exiting time, and the going-out time; and
outputting evaluation information about the parking lot, the evaluation information being based on the index value related to the environmental load for the vehicle coming in and going out of the parking lot within a designated evaluation period of time.
   (2)

The evaluation method according to the above-described (1), wherein the evaluation information about the parking lot is output in response to receiving an information request including designation of the evaluation period of time from an information terminal that receives user input.

(3)

The evaluation method according to the above-described (1) or (2), wherein the index value related to the environmental load is at least one of a fuel consumption amount or a CO2 emission from when the vehicle comes in the parking lot to when the vehicle goes out of the parking lot.

(4)

The evaluation method according to any one of the above-described (1) to (3), further comprising:
storing fuel consumption information for each predetermined vehicle type and a correlation coefficient for converting the fuel consumption information into actual fuel consumption information about movement from when the vehicle comes in the parking lot to when the vehicle goes out of the parking lot;
identifying a vehicle type of the vehicle based on the first image; and
calculating the index value related to the environmental load by using the fuel consumption information read in accordance with the vehicle type having been identified, the correlation coefficient, and a movement distance in the parking lot of the vehicle based on the travel route having been identified.
   (5)

The evaluation method according to the above-described (4), wherein the correlation coefficient is determined in accordance with at least one of a movement time in the parking lot of the vehicle based on the coming-in time, the entering time, the exiting time, and the going-out time, an average speed in the parking lot of the vehicle based on the movement time and the movement distance, the vehicle type of the vehicle, or a model year of the vehicle.

(6)

The evaluation method according to any one of the above-described (1) to (3), further comprising outputting display information for causing an information terminal of a user to display evaluation information as the evaluation information about the parking lot.

(7)

The evaluation method according to the above-described (6), wherein the display information is information for displaying a total value of index values related to the environmental load within the evaluation period of time.

(8)

The evaluation method according to the above-described (6), wherein the display information is information for displaying a transition of an index value related to the environmental load within the evaluation period of time.

(9)

The evaluation method according to the above-described (2), wherein the information request includes designation of a resolution for a section of the index value related to the environmental load within the evaluation period of time in a case where a transition of the index value is displayed.

(10)

The evaluation method according to any one of the above-described (1) to (9), further comprising outputting, as the evaluation information about the parking lot, control information for operating a facility provided in the parking lot in accordance with an index value related to the environmental load within the evaluation period of time.

(11)

The evaluation method according to the above-described (10), wherein the control information is information for controlling at least one of ventilation of the parking lot or opening/closing of a temporary entering/exiting gate that controls the number of compartments of the parking lot.

(12)

A program for causing a computer to execute the evaluation method according to any one of the above-described (1) to (11).

(13)

A recording medium (computer program product) in which the program according to the above-described (12) to be executed by a computer is recorded.

(14)

An evaluation device performing communication with each of first to third cameras, the first camera serving to image a vehicle coming in a parking lot, the second camera serving to image the vehicle in the parking lot, the third camera serving to image the vehicle going out of the parking lot, the evaluation device comprising:
a memory in which a computer program is stored; and
a processor connected to the memory and configured to perform processing by executing the computer program read from the memory, the processing including:
   acquiring a first image from the first camera, and identifying, based on the first image, a vehicle number indicating the vehicle and a coming-in time when the vehicle comes in the parking lot;
   acquiring a second image from the second camera, and identifying, based on the second image, a travel route of the vehicle in the parking lot, an entering time when the vehicle enters a compartment of the parking lot, and an exiting time when the vehicle has exits from the compartment;
   acquiring a third image from the third camera, and identifying, based on the third image, a going-out time when the vehicle goes out of the parking lot;
   calculating an index value related to an environmental load from when the vehicle comes in the parking lot to when the vehicle goes out of the parking lot, the index value being calculated based on the coming-in time, the travel route, the entering time, the exiting time, and the going-out time; and
   outputting evaluation information about the parking lot, the evaluation information being based on the index value related to the environmental load for the vehicle coming in and going out of the parking lot within a designated evaluation period of time.
      (15)

An evaluation system including the first camera, the second camera, the third camera, and the evaluation device according to the above-described (14).

What is claimed is:

1. An evaluation method in an evaluation device, the evaluation device performing communication with each of a first camera that images a vehicle coming in a parking lot, a second camera that images the vehicle in the parking lot, and a third camera that images the vehicle going out of the parking lot, the evaluation method comprising:
acquiring a first image from the first camera, and identifying, based on the first image, a vehicle number indicating the vehicle and a coming-in time when the vehicle comes in the parking lot;
acquiring a second image from the second camera, and identifying, based on the second image, a travel route of the vehicle in the parking lot, an entering time when the vehicle enters a compartment of the parking lot, and an exiting time when the vehicle exits from the compartment;
acquiring a third image from the third camera, and identifying, based on the third image, a going-out time when the vehicle goes out of the parking lot;
calculating an index value related to an environmental load from when the vehicle comes in the parking lot to when the vehicle goes out of the parking lot, the index value being calculated based on the coming-in time, the travel route, the entering time, the exiting time, and the going-out time; and
outputting evaluation information about the parking lot, the evaluation information being based on the index value related to the environmental load for the vehicle coming in and going out of the parking lot within a designated evaluation period of time.

2. The evaluation method according to claim 1, wherein the evaluation information about the parking lot is output in response to receiving an information request including designation of the evaluation period of time from an information terminal that receives user input.

3. The evaluation method according to claim 1, wherein the index value related to the environmental load is at least one of a fuel consumption amount or a CO2 emission from when the vehicle comes in the parking lot to when the vehicle goes out of the parking lot.

4. The evaluation method according to claim 1, further comprising:
storing fuel consumption information for each predetermined vehicle type and a correlation coefficient for converting the fuel consumption information into actual fuel consumption information about movement from when the vehicle comes in the parking lot to when the vehicle goes out of the parking lot;
identifying a vehicle type of the vehicle based on the first image; and
calculating the index value related to the environmental load by using the fuel consumption information read in accordance with the vehicle type having been identified, the correlation coefficient, and a movement distance in the parking lot of the vehicle based on the travel route having been identified.

5. The evaluation method according to claim 4, wherein the correlation coefficient is determined in accordance with at least one of a movement time in the parking lot of the vehicle based on the coming-in time, the entering time, the exiting time, and the going-out time, an average speed in the parking lot of the vehicle based on the movement time and the movement distance, the vehicle type of the vehicle, or a model year of the vehicle.

6. The evaluation method according to claim 1, further comprising outputting display information for causing an information terminal of a user to display evaluation information as the evaluation information about the parking lot.

7. The evaluation method according to claim 6, wherein the display information is information for displaying a total value of index values related to the environmental load within the evaluation period of time.

8. The evaluation method according to claim 6, wherein the display information is information for displaying a transition of an index value related to the environmental load within the evaluation period of time.

9. The evaluation method according to claim 2, wherein the information request includes designation of a resolution for a section of the index value related to the environmental load within the evaluation period of time in a case where a transition of the index value is displayed.

10. The evaluation method according to claim 1, further comprising outputting, as the evaluation information about the parking lot, control information for operating a facility provided in the parking lot in accordance with an index value related to the environmental load within the evaluation period of time.

11. The evaluation method according to claim 10, wherein the control information is information for controlling at least one of ventilation of the parking lot or opening/closing of a temporary entering/exiting gate that controls the number of compartments of the parking lot.

12. An evaluation device performing communication with each of first to third cameras, the first camera serving to image a vehicle coming in a parking lot, the second camera serving to image the vehicle in the parking lot, the third camera serving to image the vehicle going out of the parking lot, the evaluation device comprising:
a memory in which a computer program is stored; and
a processor connected to the memory and configured to perform processing by executing the computer program read from the memory, the processing including:
acquiring a first image from the first camera, and identifying, based on the first image, a vehicle number indicating the vehicle and a coming-in time when the vehicle comes in the parking lot;
acquiring a second image from the second camera, and identifying, based on the second image, a travel route of the vehicle in the parking lot, an entering time when the vehicle enters a compartment of the parking lot, and an exiting time when the vehicle has exits from the compartment;
acquiring a third image from the third camera, and identifying, based on the third image, a going-out time when the vehicle goes out of the parking lot;
calculating an index value related to an environmental load from when the vehicle comes in the parking lot to when the vehicle goes out of the parking lot, the index value being calculated based on the coming-in time, the travel route, the entering time, the exiting time, and the going-out time; and
outputting evaluation information about the parking lot, the evaluation information being based on the index value related to the environmental load for the vehicle coming in and going out of the parking lot within a designated evaluation period of time.
